(19) United States
(12) Patent Application Publication
(10) Pub. No.: US 2017/0346388 A1
(43) Pub. Date: Nov. 30, 2017

(54) AC CHOPPER POWER SUPPLIES

(71) Applicants: Jacobo Frias, Bronx, NY (US); Jules E. Wong, Edgewater, NJ (US)

(72) Inventors: Jacobo Frias, Bronx, NY (US); Jules E. Wong, Edgewater, NJ (US)

(21) Appl. No.: 15/168,197

(22) Filed: May 30, 2016

(51) Int. Cl. H02M 1/34

(52) U.S. Cl. CPC H02M 1/34

(57) ABSTRACT

A new method for the construction of adjustable AC and DC power supplies is proposed based on adjusting the RMS value of the utility voltage by providing the non-conducting periods centered at the time where the sinusoidal voltage is maximum. This technique minimizes the peaks of the voltage that are normally applied to the loads by the prior arts. Among others, the benefits are smoother control and torque of motor loads, and simpler construction of transformerless power supplies.

This application is a continuation of Application No. 62/168,864 filed on May 31, 2015. This invention relates generally to power supplies of the type AC chopper. The conduction angle of the AC supplied voltage is manipulated to control the effective voltage being delivered to a load.

### BACKGROUND OF THE INVENTION

In general, electric loads can be classified as type AC or DC depending on the voltage waveform applied to these loads. FIG. 1 and FIG. 2 illustrate typical waveforms of AC and DC voltages, respectively. The AC voltage 100 shown in FIG. 1 can be converted to a DC full wave rectified voltage 150 as shown in FIG. 2 by the use of rectifier diodes.

A method to control the power delivered to an electric load is shown in FIG. 3 and it is based on controlling the conduction angle of the AC voltage 100 and DC voltage 150. FIG. 3 represents a voltage waveform 200 with a conduction angle greater than 90°. This type of control is normally performed with switching elements such as Silicon Controlled Rectifiers (SCR) better known as Thyristors and Triacs. Once the SCR is turned on, i.e. at time 10, it will turn off at time 6 when its current is zero or below a threshold level.

Another method used to control the power delivered to a load, consist of using Pulse Width Modulation (PWM) techniques. A sketch for a PWM waveform 250 for AC load applications is shown in FIG. 4. The PWM application normally requires rectifying and filtering the voltage 150, which rises the DC voltage level to an amplitude corresponding to approximately the maximum peak voltage occurring at times 4, 7. Then, a series of pulses is generated having a constant amplitude equal approximately to the maximum peak value of the sinusoidal voltage 100 occurring at times 4, 7. The Root Main Square (RMS) value of the voltage 250 is controlled by adjusting the duty cycle of each pulse.

Another prior art technique for controlling the Root Mean Square (RMS) value of AC voltages is known as AC PWM chopper. When the sinusoidal input voltage 100 is gated by the train of pulses 300 shown in FIG. 5, a chopped AC voltage 350 is obtained as illustrated in FIG. 6. The frequency and duty cycle of the pulses 14 will affect the effective or Root Mean Square (RMS) value of the prospective sinewave 100.

Another prior art technique for limiting the power applied to a load consists of clipping the voltage as shown in FIG. 7. The prospective voltage 150 is clipped to a voltage level 18. The clipping of the voltage can be implemented with Zener diodes. However, this technique is very inefficient; and it is only practical for small power applications.

There is a market need for AC and DC power supplies that can provide loads with voltages having lower peaks while maintaining high integration and efficiency at low cost.

### SUMMARY OF THE INVENTION

The proposed inventive concept comprises regulating the RMS value of sinusoidal voltages by changing the duration of the turned OFF periods that are centered with respect to the time corresponding to the peak voltage of each semi-cycle. By allowing the conduction time at the beginning and the end of each half cycle of the sinusoidal voltage, the RMS value of the voltage is increased while avoiding exposing the load to higher voltage values of the sinusoidal voltage.

The concept is suitable for limiting the inrush of motor loads based on decreasing the turn OFF periods sequentially. Similarly, the inrush current of motor loads can be controlled by sequentially increasing the conduction time at the beginning and the end of each semi-cycle.

The above concept can be extended to the construction of low voltage power supplies by adding to the above concept in-between pulses that can be attenuated to a predetermined voltage range by a filter stage. In this way low voltage power supplies can be realized without the use of step down transformers resulting in increased energy efficiencies, integration, and cost savings due to simpler construction.

### BRIEF DESCRIPTION OF THE DRAWINGS

FIG. 1 illustrates a sketch of the typical waveform of a sinusoidal voltage

FIG. 2 represents the DC full wave rectification of the sinusoidal voltage shown in FIG. 1.

FIG. 3 represents a typical output voltage resulting from circuits using a Silicon Controlled Rectifiers or thyristors.

FIG. 4 represents a typical Pulse Width Modulation of AC voltages.

FIG. 5 represents a typical train of pulses used to generate the AC PWM chopped voltage of FIG. 6.

FIG. 6 illustrates a typical voltage of an AC PWM chopper.

FIG. 7 represents a typical voltage clipped by Zener diodes.

FIG. 8 illustrates a typical AC voltage waveform based on the proposed concept.

FIG. 9 illustrates the AC voltage waveform of FIG. 8 having larger conduction times.

FIG. 10 illustrates the DC voltage waveform after rectification of the voltage shown in FIG. 9.

FIG. 11 illustrates a typical DC voltage waveform obtained after processing the voltage in FIG. 10 through a filter stage.

FIG. 12 illustrates the DC voltage waveform shown in FIG. 11 having long turn OFF times.

FIG. 13 illustrates a typical DC voltage waveform obtained by adding in-between pulses to the voltage shown in FIG. 12.

FIG. 14 illustrates the voltage waveform obtained after applying a filter stage to the voltage shown in FIG. 13.

FIG. 15 illustrates an embodiment of a DC power supply based on the proposed concept in the form of a simplified single-line block diagram.

FIG. 15a illustrates an embodiment of a typical filter stage of the type pi.

FIG. 15b illustrates an embodiment of a typical filter stage which includes a rectifier diode.

FIG. 16 illustrates an embodiment of a DC power supply based on the proposed concept in the form of a simplified wiring diagram.

FIG. 17 illustrates an embodiment of an AC power supply based on the proposed concept in the form of a simplified wiring diagram.

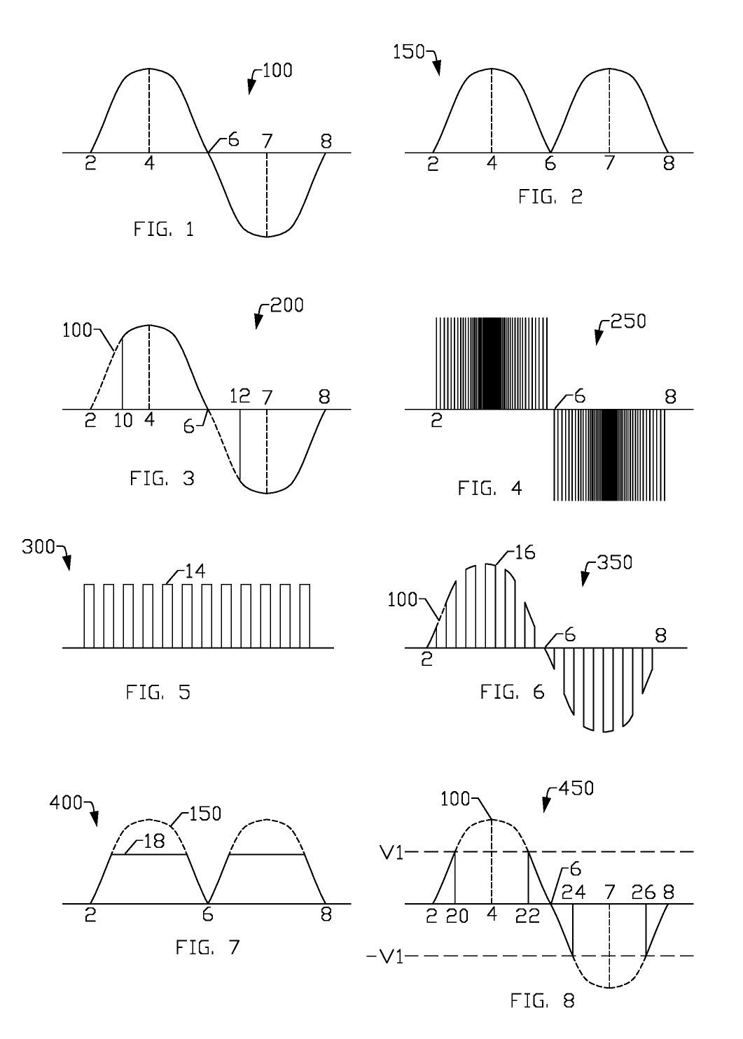

### DETAILED DESCRIPTION OF THE INVENTION

A common problem to all the above mentioned existing prior art is that increasing the power supplied to the load implies applying higher voltage peaks to the electric loads than their rated voltage. Lowering the maximum peak voltage applied to a load in an efficient manner requires the use of additional components such as step down transformers. The latter still decreases the efficiency, while increasing the complexity and cost of power supplies. Furthermore, the voltage overshoot can affect the performances of the control, i.e., motor loads can experience pulsating torques, flickering of the light intensity, etc.

The proposed inventive concept can be illustrated by the voltage waveform 450 shown in FIG. 8. The conduction times are restrictive to the beginning and end of each half-cycle of the sinusoidal voltage 100 and defined by the time intervals 2-20, 22-6, 6-24, and 26-8. The benefits of supplying the loads with rated RMS voltages having lower peaks include lower in-rush currents and reduced torque pulsations among others. Important applications for these proposed power supplies can be powering AC/DC loads such as motors, heaters, lighting, etc.

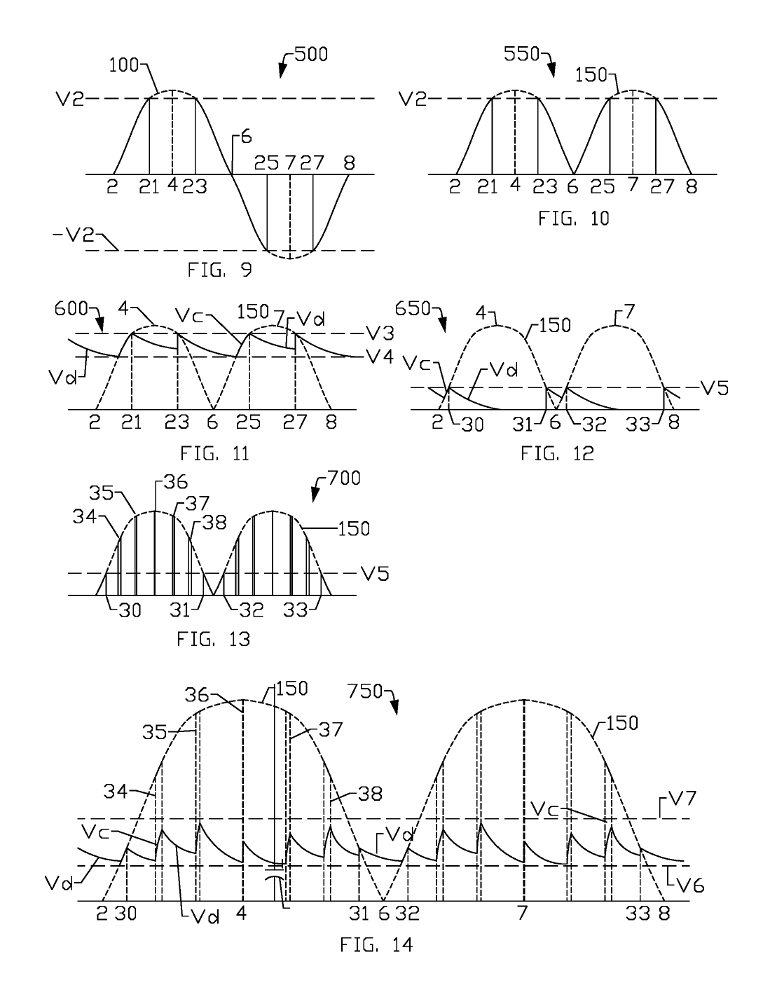

The RMS value of the voltage 450 can be increased by increasing the conduction times at the beginning and end of each half-cycle. This condition is shown by the voltage 500 in FIG. 9, in which the time intervals 21-23 and 25-27 are smaller than the ones shown in voltage 450. Hence, a larger RMS value of the voltage 500 can be obtained with respect to the voltage 450 while excluding the higher voltages in the neighborhood of the peak voltage at time 4, 7 of the prospective sinusoidal voltage 100. On the contrary, the voltages 200, 250, and 300 also change their RMS values but they expose the loads to the higher peak voltages in the vicinity of times 4, 7.

FIG. 17 illustrates an embodiment of an AC power supply based on the concept shown in FIG. 10. The circuit 900 is a simplified wiring diagram incorporating two IGBT transistors acting as the switching elements 82, 84 and operating in an alternate mode. For example, the voltage waveform 500 can be generated by turning the transistor 84 ON during the time intervals 2-21 and 23-6, and turning transistor 82 on during the time intervals 6-25 and 27-8. All transistors can be turned OFF at the zero crossings represented by the times 2, 6, and 8. As noted, the RMS value of the voltage 500 is adjusted by increasing the conduction times of the switching transistors 82, 84 while limiting the peak voltages to the V3 and V4 levels. As a result, the higher voltage peaks of the input AC sinusoidal voltage are not unnecessarily passed on to the load.

Equivalently, the proposed concept can be described in terms of the turn OFF time intervals of the switching elements 82, 84. That is, the RMS of the voltages 450, 500 can be adjusted by changing the duration of the non-conduction times 20-22, 24-26, 21-23, and 25-27. These time intervals are centered with respect to the vertical lines corresponding to times 4, 7 resulting in each semi-cycle having two symmetrical voltages with peak values V1, V2.

The operation of the switching devices 82, 84 alternates from ON to OFF and vice versa at the zero crossing times 2, 6, 8 shown in FIG. 8. The blocking action of the rectifier diodes 76, 78 allows for the implementation of a simple control method. For instance, the control lines 80, 86 can have an active default state to maintain the conduction state of the switching elements 82, 84. In this way, the switching elements 82, 84 can remain ON at all times, except during the turn OFF periods 21-23 and 25-27, which alternate between two semi-cycles. Depletion mode MOSFET transistors are suitable for this application because they have an ON default state. Under this scenario, the control lines 80, 86 can be made active to turn OFF the switching elements at time intervals 21-23 and 25-27. This control scheme minimizes the number of switching operations of the transistors 82, 84.

A Snubber element 88 can be added when having loads 92 with high inductance characteristics to improve the protection against dangerous voltage spikes.

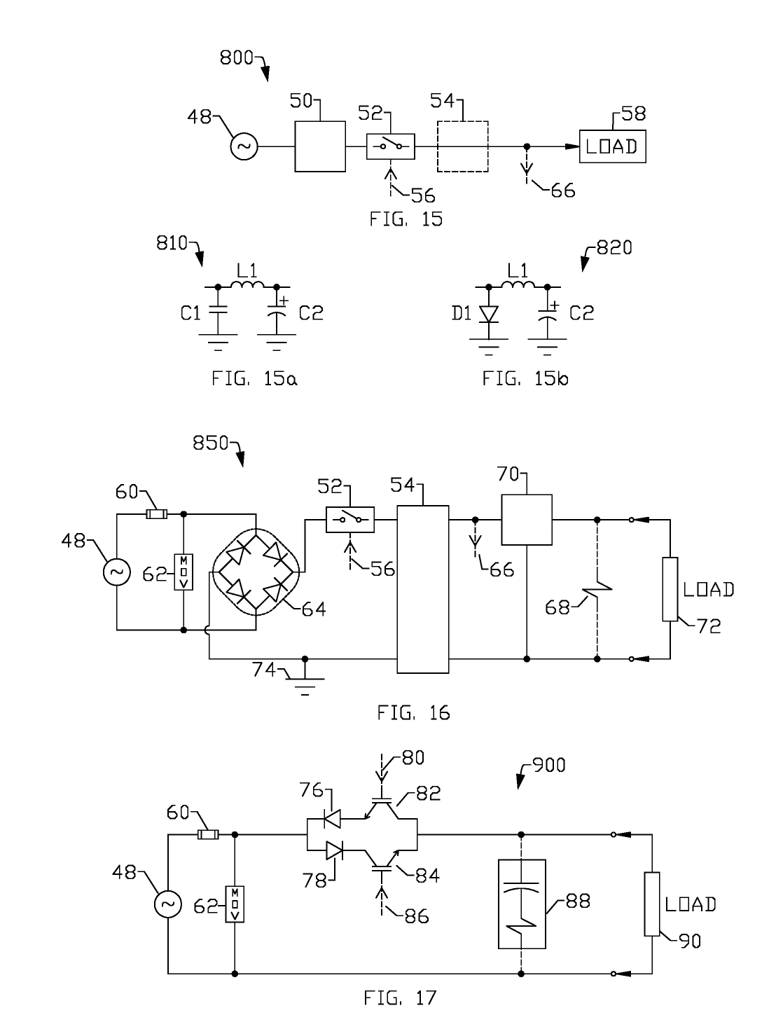

The AC waveform 500 can be rectified to obtain the DC full wave rectified voltage 550 shown in FIG. 10. The circuit 800 shown in FIG. 15 illustrates a simplified single line block diagram for an embodiment used to implement the voltage 550. The input AC voltage 48 passes through a full wave bridge rectifier 50 to obtain the DC voltage 150. In turn, the DC voltage 150 is input to the switching element 52 that is controlled by the control line 56. The output of the switching element 52 is the voltage 550 shown in FIG. 10. In addition, the voltage 550 can be input to a filtering stage 54 to increase the DC component as illustrated by the voltage 600 in FIG. 11. The filter stage 54 can include capacitors, inductors, resistors, diodes, and other active components. The monitoring line 66 can function as a feedback line used to provide automatic adjustments of the output voltages 550, 600.

Circuit 850 is a simplified two wire representation of the circuit 800 with an additional voltage regulation stage 70. The surge arrestor 62 can provide additional protection of the circuit 850 against overvoltage transients coming from the utility line voltage 48.

When the voltage 150 in FIG. 10 starts to rise at times 2,6 the switching element 52 of the circuit 800 is turned ON by the control line 56 coming from the control circuit (not shown) and it is then turned OFF at times 21, 25 when the voltage 150 has reached the voltage level V3. The prospective voltage 150 continue to increase to a maximum peak voltage at time 4 and then decreases back again to the voltage level V3 at times 23, 27 when the switching element 52 is turned back ON until the voltage 150 decreases to zero at times 6, 8 when the switching element 56 is again turned OFF.

FIG. 15a and FIG. 15b show two embodiments 810, 820 of simple filtering stages 54 in pi-configurations. The output voltage is taken across the capacitor C2. The inductance L1 can limit the magnitude of the current at the instant when the switching element 52 is first turned ON.

The effects of adding a filter stage 54 can be illustrated by the voltage 600 shown in FIG. 11. The charging voltage Vc of the capacitor C2 will tend to exponentially charge up to the voltage V3 during the conduction periods of the switching element 52. The discharging voltage Vd of the capacitor C2 will tend to discharge exponentially down to voltage V4 during the non-conduction time periods of the switching element 52 and whenever the prospective voltage 150 falls below the capacitor voltage Vc.

The DC voltage 600 contains AC voltage ripples due to the charge and discharge currents of the capacitor C2 that make the capacitor voltage fluctuate. The ripples can increase with increasing non-conduction times or turned OFF periods of the switching element 52 and larger load currents. In events where the turn OFF periods are long enough or the loads are large enough, the discharging voltage Vd at the capacitor C2 can discharge down to zero prior to the conduction time of the switching element 52. This event is illustrated by the voltage 650 shown in FIG. 12. The low magnitude of the peak voltage V5 combined with relatively large turned OFF periods during time intervals 30-31 and 32-33 can make the design of the filter stage 54 impractical. However, the proposed concept can yet be extended to provide an acceptable voltage performance as explained below.

A solution to the challenge presented by the waveform of the voltage 650 is illustrated by the voltages 700 shown in FIG. 13. In addition to the conduction periods at the beginning and the end of the each semi-cycle, a series of in-between pulses, i.e., 34, 35, 36, 37, 38, etc. The amplitudes of the in-between pulses follow the sinusoidal envelope of the voltage 150.

The overshoot of the in-between pulses can be mitigated with a filter stage 54. The voltage 750 shown in FIG. 14 is the result of applying a filter stage 54 to the voltage 700. Threshold voltages V6 and V7 can represent the lower and upper limits for the allowable voltage range of the variations of the ripples generated by the charging and discharging voltages Vc, Vd of the capacitor C2 voltage. Assume that the voltage at the capacitor C2 cannot be allowed to fall below the voltage level V6 or to rise above the voltage level V7. Voltage Vc represents a typical exponential increase of the voltage at the capacitor C2, while the voltage Vd represents a typical exponential decrease of the voltage. Because the voltage at the capacitor C2 cannot change instantaneously, the voltage fluctuations can be guaranteed to be within the allowable range V6, V7 by controlling the number of pulses and the duration of each pulse.

The exact number and duration of the in-between pulses will depend on the requirements of a particular application; however, a general guideline can be established with the help of a mathematical model to estimate and control the variations of the voltage at the output of the filtering system 54. Important parameters to consider are the charging and discharging time constants τc, τd of the filter stage 54, the instantaneous value V(t) of the sinusoidal voltage 150, and the residual voltage Vo at the capacitor C2. τc, τd, V(t) and Vo determine how fast Vc, Vd approach their target voltages V6, V7. If a constant load and frequency of the in-between pulses are assumed, the duty cycle of the pulses can be a function of the magnitude of the sinusoidal voltage V(t) for the specific time the pulses occur at time intervals 30-31 and 32-33.

As illustrated in FIG. 14, the time ON duration of the in-between pulses can decrease for higher levels of the voltage 150. For instance, the duration of the pulse 36 is smaller than the duration of the pulse 35 which in turn is smaller than the duration of the pulse 34. The charging speed of the voltage at the capacitor C2 is influenced not only by the charging time constant τc but also by the instantaneous value V(t) of the sinusoidal voltage 150 at the time when the switching element 52 is turned ON during the time intervals 30-31 and 32-33. Therefore, at lower levels of the voltage 150, the charging voltage Vc increases at slower rates allowing for longer duration of the in-between pulses, i.e., 34. Correspondingly, at higher levels of the voltage 150, the charging voltage Vc increases at higher rates requiring narrower duration of the in-between pulses, i.e., 36. To compensate for the sinusoidal variations of the supplied voltage 150, the control circuit monitoring line 66 can decrease the width of the in-between pulses as the voltage 150 increases and vice versa. Because voltage 150 is maximum at times 4, 7, the charging voltage Vc experiences the higher increasing rate forcing the pulse 36 to be the narrowest.

The equivalent load resistance Rd is also influenced by the loads 58, 72. For larger load currents, the resistance Rd and the discharging time constant τd become smaller resulting in faster discharge rates of the capacitor C2 voltage Vd. To compensate for higher loads, the control circuit reading line 66 can increase the number of pulses so as to decrease the turn OFF time between the pulses. Because Rd is a minimum at the largest load, the capacitor C2 experiences the highest decreasing rate of the voltage Vd forcing the number of pulses to be maximum. At the same time, a higher number of pulses can translate into thinner pulse widths. That is, because the discharging time becomes smaller with higher number of pulses, the conduction time of the pulses can be made smaller resulting in smaller voltage ripples, which in turn allows for smaller ranges of the band defined by the voltage levels V6, V7. If the voltage levels V6, V7 represent the allowable range for operating the voltage regulator 70, then, the load 72 can be provided with a constant DC voltage V6 while still maintaining high energy efficiencies.

For a given circuit 850, the number and duration of the in-between pulses can be a dynamic process to react to changes of the load 72 and to changes of the power supply 48. The control scheme can be implemented by operating the switching element 52 based on the allowable voltage range defined by V6, V7. For example, the switching element 52 can be turned ON whenever the discharging voltage Vd of the capacitor C2 is equal to or lower than V6, and the switching element can be turned OFF whenever the charging voltage Vc of the capacitor C2 is equal to or greater than V7. The embodiments of the control circuit (not shown) can be of the type analog, digital, or microprocessor (not shown.)

The above proposed concept can allow for power supplies to feature high integration and efficiency at lower costs thanks to the elimination of power transformers and a reduced number of components.

What is claimed is:

1. A power supply used for providing AC and DC power to electric loads, wherein the power supply:
is adapted to receive a sinusoidal voltage;
comprises a switching device operated in such a way as to provide non-conduction periods symmetrically centered with respect to the time line passing through the maximum voltage of each semi-cycle of said sinusoidal voltage; and,
said power supply being capable of changing the RMS value of the sinusoidal voltage by adjusting the duration of the of the non-conduction periods.

2. The power supply of claim 1, wherein the RMS value of the sinusoidal voltage is increased by sequentially decreasing the duration of the non-conduction periods of each semi-cycle.

3. The power supply of claim 1, wherein the non-conduction periods are furnished with a series of in-between pulses.

4. The power supply of claim 3, wherein the power supply comprises a filter stage capable of maintaining the amplitude of the in-between pulses within a predefined voltage range.

5. The power supply of claim 4, wherein RMS value of the output voltage is adjustable.

6. A method for an apparatus used for supplying power to electric loads exhibiting inrush currents, wherein the apparatus
is adapted to accept a sinusoidal voltage;
comprises a switching element capable of providing each semi-cycle of the sinusoidal voltage with a non-conduction time interval which center is aligned with the maximum voltage peak; and,
the method comprising limiting the inrush current by sequentially decreasing the duration of the non-conduction time intervals.
